(19) United States
(12) Patent Application Publication
(10) Pub. No.: US 2005/0212653 A1
(43) Pub. Date: Sep. 29, 2005

(54) Security system to provide increased security to lockable apparatuses

(76) Inventors: Mike Hertel, Burke, VA (US); Bruce Wituck, Temple Hill, MD (US)

Correspondence Address: STANZIONE & KIM, LLP, 1740 N STREET, N.W., FIRST FLOOR, WASHINGTON, DC, 20036, US

(21) Appl. No.: 10/807,269

(22) Filed: Mar. 24, 2004

(51) Int. Cl. G05B 19/00

(52) U.S. Cl. 340/5.22; 340/5.65; 340/5.32; 307/10.5

(57) ABSTRACT

A security system providing increased security to storage type units and/or other valuable apparatuses. The security system works together with a manufacturer installed locking mechanism of the storage type unit or other valuable apparatuses. The security system prevents unauthorized users from accessing or using the storage type unit or other valuable apparatuses, even if the manufacturer installed locking mechanism has been penetrated by an unauthorized user having sufficient knowledge to operate the manufacturer installed locking mechanism without using a manufacturer provided key. The security system also provides varying levels of security to different components of a storage type unit or other valuable apparatuses so that users with different levels of authority are prevented from accessing and/or using certain compartments of the storage type unit or other valuable apparatuses that require a higher level of authority than provided to the user.

### BACKGROUND OF THE INVENTION

1. Field of the Invention

The present invention is directed to a security system that can be applied to a storage unit or other valuable items having manual locks provided therein to increase the security thereof.

2. Description of the Related Art

It is well known to provide locks on storage units or other valuable items in order to provide security against access or use thereof by an unauthorized user. Most commonly, when such storage units or other valuable items are manufactured, they are manufactured with a manual key locking device or other simple locking device, which can prevent unauthorized users from accessing the storage units or using the valuable items without being given the proper authorization, such as being given a corresponding key to operate the manufacturer installed key locking device.

Nevertheless, even with the use of the locking devices provided with the storage units or other valuable items, such storage units or other valuable items can still be accessed by an unauthorized user if the unauthorized user has a sufficient amount of knowledge about how these locking devices are operated. For example, the unauthorized user may have sufficient knowledge to be able to operate the manufacturer installed locking device of the storage units or other valuable items without being provided with a key normally used to operate them.

Due to the common occurrence of unauthorized users operating manufacturer installed locking devices on storage units and other valuable items, such as automobiles, for example, to access and/or use the same without authorization, aftermarket locking units have been provided to increase the security of the storage units and other valuable items. The aftermarket locks are intended to provide that even if an unauthorized user has sufficient knowledge to gain access to a manufacturer installed locking devices on storage units or other valuable items, the aftermarket locking units will increase the security of the storage units and other valuable items by forcing the unauthorized user to have to go through the trouble of operating another lock as well as the manufacturer installed locking device in order to gain access to the storage units, or to use the other valuable items.

One example of aftermarket locks are padlocks that can be connected to a storage unit in order to lock an opening member, such as a door, to the storage unit, such that the door can not be opened with respect to the storage unit to allow access to the interior of the storage unit. These aftermarket padlocks are usually operable with a manual key that is provided with the padlock to correspond therewith, and come in many different forms to be connectable to many different types of storage units.

Another example of an aftermarket lock is a mechanism called THE CLUB™, which is a mechanism that is operated to lock and unlock, by a manual key, to lock onto a steering wheel of a motor vehicle. Once THE CLUB™ is attached to the steering wheel of a motor vehicle, it can be locked with the manual key such that even if the motor vehicle is started by an unauthorized user by penetrating an ignition system, or even bypassing the ignition system, the motor vehicle cannot be operated properly since the steering wheel is a necessary component to operate the motor vehicle properly. Only users in possession of the manual key that corresponds to THE CLUB™ can unlock THE CLUB™, thus providing only authorized users the ability to properly operate the motor vehicle.

However, even though these aftermarket locking units provide additional security to storage units or other valuable items by providing an additional manual key locking unit to the already manufacturer installed locking device, thus making it twice as difficult for an unauthorized user to access storage units or use other valuable items, these aftermarket locking units can also be penetrated by those without authorization to do so. Accordingly, even though unauthorized persons have the additional task of penetrating an aftermarket locking unit in addition to penetrating a locking device manufactured together with storage units or other valuable items before they can access and/or use the same, these unauthorized persons having sufficient knowledge of how to penetrate the aftermarket locking units can do so with little more effort than it takes to penetrate the integrally manufactured locking devices.

### SUMMARY OF THE INVENTION

Accordingly, it is an aspect of the present invention to provide a security system that can be installed on storage units or other valuable items which can not be penetrated, thus increasing the security of a storage unit or other valuable items.

Additional aspects and advantages of the invention will be set forth in part in the description which follows and, in part, will be obvious from the description, or may be learned by practice of the invention.

The foregoing and/or other aspects of the present invention are achieved by providing a security system to increase the security of a manual key operated unit, comprising: an electronic key having an identification code therein; an electronic key reader to read the identification code of the electronic key; and a microprocessor to operate a necessary operating component of the manual key operated unit by receiving the identification code read by the electronic key reader and then operating the necessary operating component for a predetermined amount of time if the correct identification code is read, otherwise operating the necessary operating component for a duration of time in which the manual key operated unit is operated by a manual key if the manual key operates the manual key operated unit within the predetermined amount of time.

The foregoing and/or other aspects of the present invention are also achieved by providing a security system to increase the security of a manual key operated motor vehicle, comprising: an electronic key having an identification code therein; an electronic key reader to read the identification code of the electronic key; and a microprocessor to operate a necessary operating component of the motor operated vehicle by receiving the identification code read by the electronic key reader and then operating the necessary operating component for a predetermined amount of time if the correct identification code is read, otherwise operating the necessary operating component for a duration of time in which the manual key operated motor vehicle is operated by a manual key if the manual key operates the operated motor vehicle within the predetermined amount of time.

The foregoing and/or other aspects of the present invention are also achieved by providing a security system to increase the security of a manual key operated unit, comprising: an electronic key having an identification code therein; an electronic key reader to read the identification code of the electronic key; and a microprocessor to operate a necessary operating component of the manual key operated unit by receiving the identification code read by the electronic key reader and then operating the necessary operating component for a predetermined amount of time if the correct identification code is detected, otherwise operating the necessary operating component for a duration of time in which the manual key operated unit is operated by a manual key if the manual key operates the manual key operated unit within the predetermined amount of time.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 illustrates a security system according to an embodiment of the present invention;

FIG. 2 illustrates a security system used with a motor vehicle according to another embodiment of the present invention;

FIG. 3A illustrates a security system used with a management system according to yet another embodiment of the present invention;

FIG. 3B illustrates a security system used with a management system according to yet another embodiment of the present invention;

FIG. 4 illustrates a method of operating the security system of FIG. 1, according to another embodiment of the present invention;

FIG. 5 illustrates a method of operating the security system of FIG. 2, according to another embodiment of the present invention;

FIG. 6 illustrates a method of operating the security system of FIG. 3A, according to another embodiment of the present invention; and

FIG. 7 illustrates a method of operating the security system of FIG. 1, according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

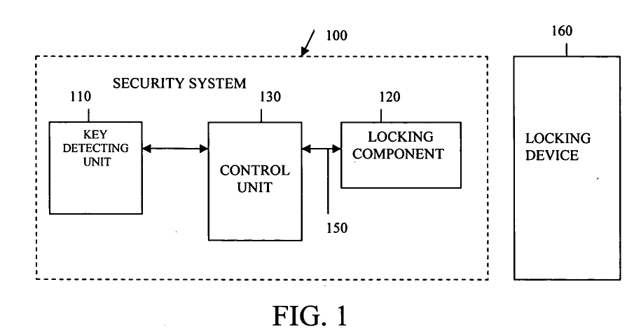

Referring to FIG. 1, a security system 100 according to an embodiment of the present invention includes a key detecting unit 110, a control unit 130 and a locking component 120. The security system 100 is used to control locking devices of an external unit, such as a locking device 160, to provide an increased security to the external unit (not shown) containing the locking mechanism(s) 160. The external unit to be secured by the security unit 100 of FIG. 1 can be any type of storage unit such as, for example, a storage unit used to contain items therein, an controlled management area, a building, a motor vehicle engine controlling unit, a motor vehicle compartment area, a storage area to store keys in an automobile dealer shop, a voter election both, etc., and can have one or more compartment areas within the unit to store different items therein. Although the external unit of this embodiment can be many different types of external units, for simplicity of understanding, the external unit referred to below will be described with reference to an external unit having one or more compartment areas.

Each compartment area of the external unit contains a locking device 160 provided therewith to lock the respective compartment area. The locking device 160 is usually operated by a manufacturer provided manual or electronic key. The electronic locking component 120 is connected with the locking device 160 of the compartment area, which in turn locks or unlocks the compartment area of the external unit. It is to be noted that since the external unit may have more than one compartment area, it is an aspect of this embodiment that the security system 100 may have as many electronic locking components 120 as there are locking devices 160 to lock a respective storage compartment area.

The security system 100 of FIG. 1 operates as follows. The security system 100 is connected with the external unit via an electrical connection connecting the locking component 120 to the locking device 160. The locking component 120 operates to prevent the locking device 160 from being operated, even though a user may attempt to operate the locking device 160 to be unlocked with the use of the manufacturer provided manual or electronic key mechanism. Accordingly, the locking component 120 operates to enable the locking device to be operated by a user having the manufacturer provided manual or electronic key mechanism.

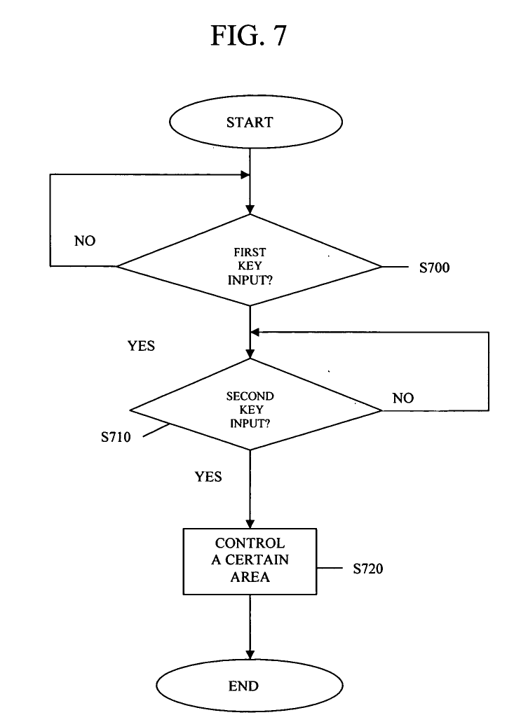

Instead of operating the locking device 160 by use of only the manufacturer provided key mechanism, as the original design of the external unit, the security system 100 controls the operation of the locking device 160 by first checking for an electronic key to be used with the key detecting unit 110. The key detecting unit 110 reads the electronic key to detect a programmed identification code within the electronic key. Once the programmed identification code has been detected, the key detecting unit 110 sends a signal to the control unit 130 indicating that the proper identification code has been detected. Then the control unit 130 sends a signal through a bi-directional line 150 to the locking component 120, which in turn will allow the locking device 160 to be operated by the manufacturer provided key for a predetermined amount of time. If the manufacturer provided key is not used to operate the locking device 160 within the predetermined amount of time, the control unit 130 receives a signal back from the locking component 120 indicating that the manufacturer provided key has not been used with the locking device 160. Then the control unit 130 controls the locking component 120 through the bi-directional line 150 to stop the locking device 160 from being operated by the manufacturer provided key. However, if the manufacturer provided key is used to operate the locking device 160 within the predetermined amount of time, the control unit 130 receives a signal from the locking component 120, through the bi-directional line 150, indicating that the manufacturer provided key has not been used with the locking device 160, at which time the control unit 130 controls the locking component 120, through the bi-directional line 150, to continue to enable the locking device 160 to be operated by the manufacturer provided key for as long as the manufacturer provided key is used to access the locking device 160 of the compartment area. Although this embodiment describes the key detecting unit 110 as one unit to detect an electronic key, the key detecting unit 110 may contain plural detection units to detect plural corresponding electronic keys, as will be described in more detail with respect to FIG. 7.

It is to be noted that the predetermined amount of time for the manufacturer provided key to access the respective locking device 160 is programmed into the control unit, and can be re-programmed for any amount of time desired by the authorized user/owner of the security system 100. The predetermined amount of time is usually set by the authorized user/owner in order to allow sufficient time for any authorized user to place the manufacturer provided key into the locking device 160 to operate the locking device 160 properly. Thus, any unauthorized users that attempt to operate the locking device 160 by a means other than by use of the proper manufacturer provided key will be prevented from doing so after the predetermined amount of time.

Moreover, even if an unauthorized user has sufficient knowledge of how to operate the locking device 160 without having the manufacturer provided key, this unauthorized user cannot operate the locking device without having the additional electronic key having the programmed identification code therein, since the security system 100 of FIG. 1 will prevent operation of the locking device 160 until a signal is received from the key detecting unit 110 indicating that the proper programmed identification code has been detected, at which time the proper manufacturer provided key may be used within a predetermined amount of time to operate the locking device 160.

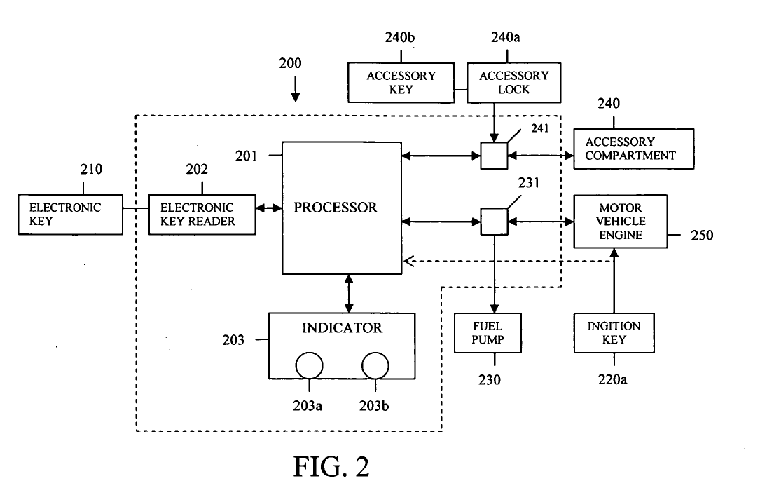

FIG. 2 illustrates a security system 200 used with a motor vehicle, according to another embodiment of the present invention. The security system 200 of FIG. 2 can be used to provide increased security to the motor vehicle, including each of its compartments, and includes a processor 201, a key detection unit 202, switching devices 231 and 241, and an indication unit 203. Here, the security system 200 is installed on the motor vehicle, such as on a dash board, etc., and is used to control one or more electrical and/or mechanical components of the motor vehicle that are required to operate the motor vehicle and/or accessory compartments within the motor vehicle. More specifically, when an electronic key 210, having a specific programmed identification code therein, is read by the electronic key reader 202, the electronic key reader 202 sends a signal to the processor 201 indicating that the proper programmed indication code has been read. The processor 201 then operates each of the switches 231 and 241 to enable the one or more electrical and/or mechanical components required to operate the motor vehicle or accessory compartments within the motor vehicle, for a predetermined amount of time.

Here, the switching units 231 and 241 are provided to enable a fuel pump 230 of the motor vehicle engine that is required to activate a motor vehicle engine 250, and an accessory compartment 240a, respectively. It is to be noted that although one accessory compartment 240 is illustrated, several accessory compartments within the motor vehicle can be controlled by the security system 200 of this embodiment. Similarly, many different components of the motor vehicle engine 250 other than the fuel pump 230 (i.e., a starter, a distributor, etc.) may be controlled by the security system 200 of FIG. 2.

The switching unit 241 is disposed to connect the accessory compartment 240 with the processor 201 so that the processor 201 can enable operation of the accessory compartment 240 according to the processor 201 itself and an accessory lock 240a, which is operated by an accessory key 240b. In other words, even when the accessory key 240b is used to operate the accessory lock 240a, the processor 201 of the security unit 200 will prevent the accessory compartment 240 from being accessed without receiving a signal from the electronic key reader 202 indicating that the proper programmed identification code has been read. Similarly, the switching unit 231 is disposed to connect the fuel pump 230 (or any other component of the engine 250) with the motor vehicle engine 250 to control the supply of fuel to the motor vehicle engine 250, thus controlling operation of the motor vehicle engine 250. Therefore, even when an ignition key 220a is used to operate the motor vehicle engine 250, the processor 201 of the security unit 200 will prevent the motor vehicle engine 250 from being operated without receiving a signal from the electronic key reader 202 indicating that the proper programmed identification code has been read.

When the processor 201 receives the signal indicating that the proper programmed identification code has been read by the electronic key reader 202, the processor enables both switches 231 and 241 for the predetermined amount of time. Further, when the manufacturer provided keys, such as the accessory key 240b and/or the ignition key 220a, are used by a user within the predetermined amount of time, the processor 201 receives signals indicating this even. As a result, the processor 201 then controls the switches 231 and 241 to enable the fuel pump 230 and the accessory compartment 240, respectively, to be operated for as long as the fuel pump 230 and the accessory compartment 240 are being operated by the respective manufacturer provided key.

The processor 201 receives a signal from the ignition system (not shown) or from the motor vehicle engine 250 indicating that the ignition key 220a has be used to operate the motor vehicle engine 250. The processor 201 can have an electrical connection to either the ignition of the motor vehicle, or can have an electrical connection directly to the motor vehicle engine 250, which sends a signal back to the processor 201 when the ignition key 220a is attempting to operate the motor vehicle engine 250, as shown by the dotted line extending from the line between the ignition key and the motor vehicle engine 250 to the processor 201. On the other hand, the processor 201 receives a signal indirectly from the accessory lock 240a indicating that the accessory key 240b has been used to operate the accessory lock 240a, which will provide access to the accessory compartment 240 once unlocked. The indirectly received signal of the processor 201 is a signal through the switching unit 241. More specifically, when the accessory key 240b is used in the accessory lock 240a, the voltage level of the signal from the processor 201 to the switching unit 241, enabling the switching unit 241 to operate the accessory compartment, is changed by a certain amount. The processor 201 then detects this change in voltage, and then makes the determination that the accessory key 240b has been used to operate the accessory compartment within the predetermined amount of time. Then the processor 201 controls the switching unit 241 to enable the accessory compartment 240 to be operated for as long as the accessory compartment 240 is being operated by the accessory key 240b.

As a result of the operations of the security system of FIG. 2, the electronic key reader 202 must first detect the electronic key 210 with the specific programmed identification code in order for the processor 201 to signal to the switching units 231 and 241 to allow the fuel pump (or other component) 230 and the accessory compartment(s) 240 to be operated. Then the ignition key 220a and/or the accessory key 240b can be used to operate the motor vehicle engine 250 and the accessory compartment 240, respectively, within the predetermined amount of time, and for the duration of use of the respective key. In contrast, even if the processor 201 receives the signal indicating that the proper programmed identification code has been read by the electronic key reader 202, if the ignition key 220a and/or the accessory key 240a are not provided by the user to operate the motor vehicle engine 250 and the accessory lock 240a (to open the accessory compartment 240), respectively, within the predetermined amount of time, the processor 201 disables the switches 231 and 241, and the process must be started again. As stated in the previous embodiment of FIG. 1, a reasonable amount of time to allow a user to use the ignition key to operate the motor vehicle engine 250 and/or use the accessory key 240b to operate the accessory lock unit 240a, to operate the ignition and/or access the accessory compartment 240, can be programmed by an authorized user/owner of the motor vehicle. In an aspect of this embodiment of the present invention, this predetermined amount of time can be re-programmed by an external PC or other programming device to suit the motor vehicle owner's personal preference.

According to another aspect of this embodiment, when the electronic key reader 202 reads the proper reference programmed identification code, the indication unit 203 lights up a green LED 203a to indicate that the proper electronic key (having a specific programmed identification code) has been used with the electronic key reader 202. In contrast, when the electronic key reader 202 reads an incorrect identification code from the electronic key 210, the indication unit 203 lights up a red LED 303b to indicate that the proper electronic key 301 has not been used with the key detection unit 302, and the processor 301 in response does not operate any of the one or more electrical and/or mechanical components required to operate the motor vehicle engine 250 or the accessory compartments of the motor vehicle.

The indication unit 203 also acts as an indicator to unauthorized users that there is a security system installed within the motor vehicle. More specifically, when the motor vehicle is not being operated, the green and red LEDs 303a and 303b alternately flash to signal that the security system 200 is installed within the motor vehicle. Thus the indication unit 203 has a multi-purpose of signaling that a security system 200 is installed in the motor vehicle, and also to signal to an user whether the proper programmed identification code has been read by the electronic key reader 202, so that the user can take the next step of using either an ignition key 220a or an accessory key 240b to attempt to operate the motor vehicle engine 250 or an accessory unit 240, respectively. Finally, when the motor vehicle is in operation, the indicator turns off.

The electronic key reader 202 may be an electronic key system such as an iButton reader, for example, the DS9092L or the DS1402D, which is a model name sold by DALLAS SEMICONDUCTOR. The processor 201 of the security system 200 then receives signals from each iButton reader, and processes the signals received to determine whether the correct identification code has been read by the iButton reader provided with the security system 200.

As a result of the security system 200, even if a user attempts to operate the motor vehicle 250 with the manufacturer provided ignition key, or operation of the motor vehicle 250 is attempted to be operated by an unauthorized user with sufficient knowledge to activate the motor vehicle engine 250 without the manufacturer provided ignition key, the security system 200 prevents the one or more electrical and/or mechanical components required to operate the motor vehicle engine 250, such as the fuel pump 230 from being used by these types of users.

In addition to the above stated advantages of the security system 200, even if a user attempts to operate any of the compartments of the motor vehicle with a manufacturer provide accessory key, or if an unauthorized user with sufficient knowledge to activate the accessory lock without a respective accessory key, the security system 200 prevents the motor vehicle compartments from being accessed by these types of users.

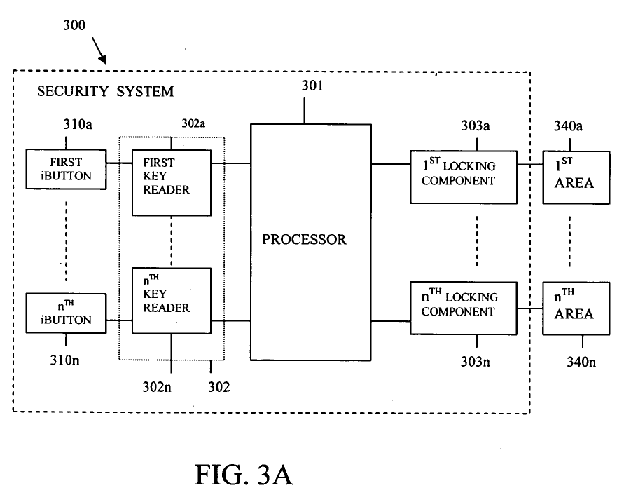

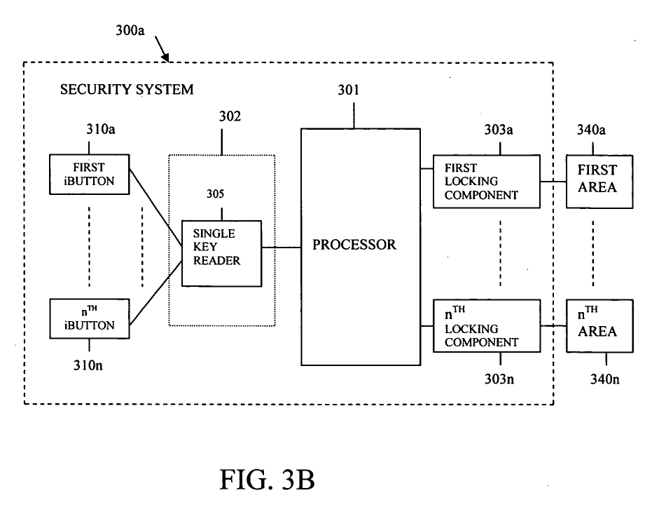

FIG. 3A illustrates a security system used with a management system according to yet another embodiment of the present invention. Referring to FIG. 3, the security system includes a processor 301 connected to a key reader unit 302 having a first key reader 302a through an nth key reader 302n. The processor 301 receives signals from each of the first key reader 302a through 302n in response to the information obtained from a first electronic key 210a through an nth electronic key 210n, to selectively operate a first area 340a through an nth area 340n of a management system (or a storage unit management system). The security system 300 of FIG. 3A also includes locking components 303a through 303n, each locking component 303a through 303n controls its respective area 340a through 340n according to signals received from the processor 301.

As stated in the previous embodiments of FIGS. 1 and 2, the key readers 302a through 302n may be an electronic key system such as iButton readers, for example, the DS9092L or the DS1402D, which is a model name sold by DALLAS SEMICONDUCTOR, to read the electronic keys 210a through 210n, which may be iButtons.

In an aspect of this embodiment of the present invention, each of the key readers 302a through 302n may be programmed to recognize one relative programmed identification code within a corresponding programmed electronic key (iButton). Thus, each of the areas 340a through 340n is controlled to become locked or unlocked in accordance with a respective programmed identification code detected by the corresponding key reader 302a through 302n. As a result, specific users of the security system 300 have authorization to access specific areas 340a through 340n of the management system (or a storage unit management system). This allows different users, having different access authority levels, to access only one or more specific areas of the areas 340a through 340n of the management system (or a storage unit management system), depending upon the level of authority provided to the authorized user.

In another aspect of this embodiment, a specific key may be provided with an identification code that each of the key readers (i.e., the iButton reader) is programmed to recognize as a correct identification code, thus acting as a master key that allows an authorized user with a highest level of authority to control each of the areas 340a through 430n of the security system, and allows this authorized user having the highest level of authority to lock and unlock each of the areas 340a through 340n with the use of one electronic key.

Once one of the key readers 302a through 302b reads a respective programmed identification code that it is looking for, the key reader that has read the identification code sends a signal to the processor 301 indicating that the proper identification code has been read to access the respective area 340a through 340n. Once the processor 301 receives the signal from one of the key readers 340a through 340n, the processor 301 sends a signal to one of the locking components 303a through 303n to control a corresponding area 340a through 340n, depending on which locking component 303a through 303n is designated to lock or unlock the respective area 340a through 340n which corresponds to the respective programmed identification code. Thus, the processor 301 can control which areas 340a through 340n of the management system (or a storage unit management system) can be accessed depending on which respective programmed identification code has been read. Accordingly, users with different levels of authority (having a predetermined electronic key with a programmed identification code therein) can access only areas of the management system which the user has been given authority to access.

FIG. 3B illustrates a security system used with a management system according to yet another embodiment of the present invention. Like reference numerals in FIG. 3B will refer to like features described above with respect to FIG. 3A. Referring to FIG. 3B, the security system 300a includes the processor 301 connected to the key reader unit 302. Here, the key reader 302 includes only one key reader 305. Here, the key reader 305 is programmed to recognize several different reference programmed identification codes within the several different electronic keys 310a through 310n. The processor 301 receives different signals from the key reader 305 in response to the specific referenced programmed identification code read by the key reader 305, to selectively operate one or more of the first area 340a through the nth area 340n of a management system (or a storage unit management system). In other words, here, only one key reader 305 is required to read several different electronic keys (iButtons) 310a through 310n, and in response, the processor 301 will operate a respective area 340a to 340n to be locked or unlocked depending on the programmed identification code read by the key reader 303. As in the embodiment of FIG. 3A, once the key reader 305 reads a respective programmed identification code corresponding to a respective area 340a through 340n, the key reader 305 sends a signal to the processor 301 indicating that a proper respective programmed identification code has been read to access one or more of the respective areas 340a through 340n. Once the processor 301 receives the signal from the key reader 305, the processor 301 sends a signal to one or more of the locking components 303a through 303n to control one or more of the corresponding areas 340a through 340n, depending on which locking component or components 303a through 303n are designated to lock or unlock the respective areas 340a through 340n corresponding to the respective programmed identification codes read. Thus, the processor 301 can control which areas 340a through 340n of the management system (or a storage unit management system) can be accessed depending on which respective programmed identification code or codes that have been read. Accordingly, users with different levels of authority (having a predetermined electronic key with a programmed identification code therein) can access only areas of the management system which the user has been given authority to access. Thus, for example, the owner of the management system (or a storage unit management system) may have an electronic key that includes each of the programmed identification codes required to operate all of the areas 340a through 340n, while a manage of management system (or a storage unit management system) may have an electronic key that includes specific programmed identification codes required to operate only specific the areas 340a through 340n in which the manager has been given authority to access. Further, an employee of management system (or a storage unit management system) may have an electronic key that includes specific programmed identification codes that allow the employee to operate only specific the areas 340a through 340n in which the employee needs to access in order to perform his/her job.

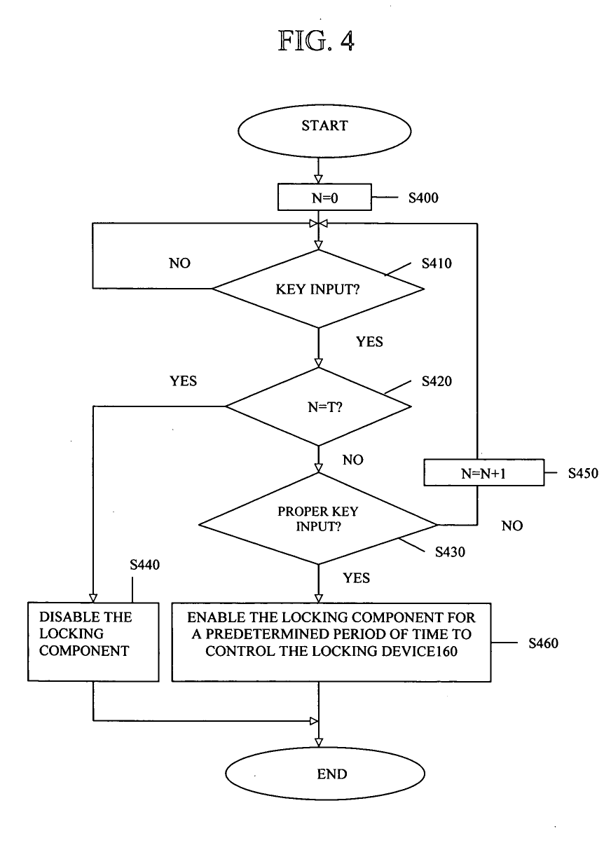

FIG. 4 illustrates a method of operating the security system 100 of FIG. 1, according to an embodiment of the present invention. In the method of FIG. 4, the number of times the security system 100 of FIG. 1 is attempted to be operated by an electronic key at the key detection unit 110 is N, which is first set to N=0 in operation S400 after no attempt has been made to operate the security system 100 for a predetermined amount of time. Next, it is determined whether an electronic key has been used at the key detecting unit 110 to access the locking device 160 in operation S410. If not, then the key detecting unit 110 continues to check for a key input. If an electronic key has been used at the key detecting unit 110, then the security system 100 determines how many times (N=?) an electronic key has been used at the key detecting unit 110 in operation S420. If an electronic key has been used at the key detecting unit 110 a number of times T (N=T), then the control unit 130 of FIG. 1 sends a signal to the locking component 120 to disable the locking component 120 in operation S440, thus preventing access to the locking device 160, at which point the security system 100 will not allow access to any user for the predetermined amount of time at which no attempt has been made to operate the security system 100. However, if a number of times N that an electronic key has been used at the key detecting unit 110 is less than a predetermined number T (N<T), then it is determined by the key detecting unit 110 if the electronic key being used is the proper electronic key having a specific programmed identification code therein, in operation S430.

If the proper electronic key has not been used, then the number N is increased by one in operation S450 and then the system goes back to the determining operation S410. However, if the proper electronic key has been used at the key detecting unit 110, then the key detecting unit 110 sends a signal to the control unit 130 indicating that the proper electronic key has been used. At this point, the control unit 130 sends a signal enabling the locking component 120 for another predetermined amount of time, thus giving the user sufficient time to access the locking device 160 by using a manufacturer provided key, or other means of accessing the locking device 160 in operation S460. As stated supra, the another predetermined amount of time can be re-programmed by use of a PC or other programmable device, in order to set the amount of time that the locking component 120 will be enabled as desired by the owner of the security system 100.

As a result of the method of this embodiment, if a user attempts to operate the locking device 160 with or without (an unauthorized user attempting to bypass the locking device lock) a manufacturer provided key, the locking device 160 will be prevented from being accessed due to the locking component 120 controlling the locking device 160 to remain disabled.

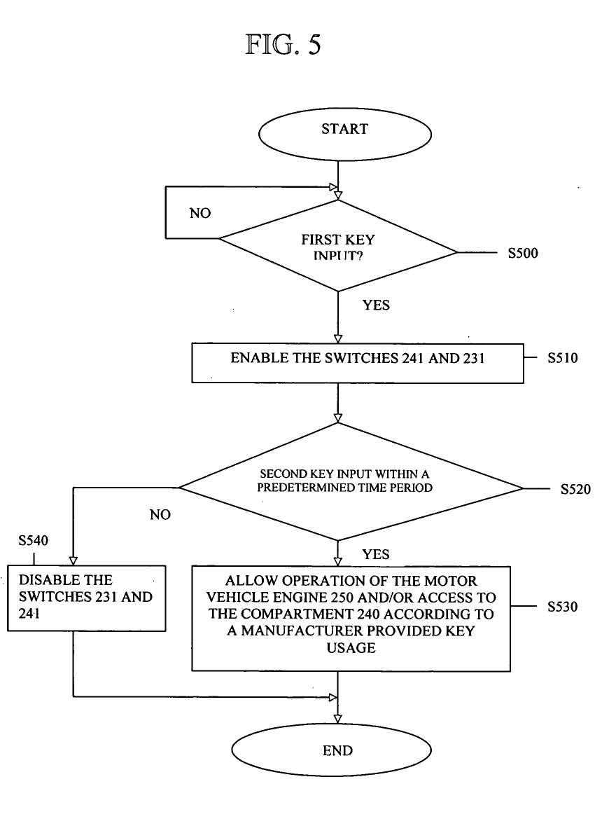

FIG. 5 illustrates a method of operating the security system 200 of FIG. 2, according to another embodiment of the present invention. In the security system of FIG. 2, it is determined whether a user has placed an electronic key 210 up to the electronic key reader 202, in operation S500. If no key has been used, then the electronic key reader 202 continues to check for the use of an electronic key. If the electronic key reader 202 has determined that a proper electronic key (having a specific identification code therein) has been used, then the processor 201 enables the switching units 231 and 241 for a predetermined time period in operation S510. This predetermined time period allows a user to operate the motor vehicle engine 250 and/or access the accessory compartment 240, etc., with a manufacturer provided key for the predetermined time period. The processor 210 makes the determination of whether the manufacturer provided key has been used by a user with the predetermined time period to operate the motor vehicle engine 250 and/or an accessory compartment 240, etc., by waiting to receive a signal from motor vehicle engine 250 and/or one or more accessory compartments 240, etc., that the manufacturer provided key has been used by a user to operate the motor vehicle engine 250 and/or an accessory compartment 240, etc., within the predetermined time period in operation S520. If the processor receives one or more signals indicating that the motor vehicle engine 250 and/or one or more accessory compartments 240, etc., have not been attempted to be accessed with a manufacturer provided key within the predetermined time period, the processor 201 then disables the switching units 231 and 241 in operation S540, and the operations of FIG. 5 begin again from START.

In contrast, if the processor 201 receives one or more signals indicating that either the motor vehicle engine 250 and/or one or more accessory compartments 240, respectively, have been attempted to be accessed by a respective manufacturer provided key within the predetermined time period, then the processor 201 continues to enable the switches 231 and 241, thus enabling operation and/or access of the motor vehicle engine 250 and/or one or more accessory compartments, respectively, for as long as the respective manufacturer provided key continues to be used to operate and/or access the motor vehicle engine 250 and/or one or more accessory compartments, respectively, in operation S630.

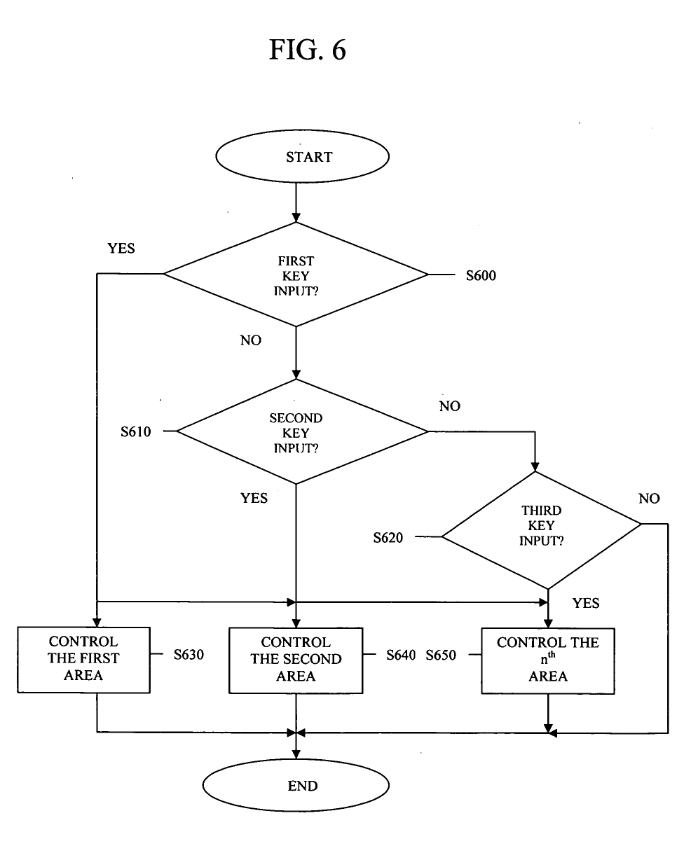

FIG. 6 illustrates a method of operating the security system of FIG. 3A or FIG. 3B, according to another embodiment of the present invention. In the security system of FIG. 3A, a user having full authorization to access or operate all of the areas 340a through 340n places a first electronic key, such as an iButton key 310a through 310n, up to the first key reader 302a of the key reader unit 302 (or the single key reader 305 in FIG. 3B), in operation S600. In this case, the user using the first iButton key 310a is authorized to access or operate any of the areas 340a through 340n in operations S630 through S650, and thus can access each of the first, second and third areas of the management system (or a storage unit management system).

Next, it is determined in operation S610 whether a second user, attempting to use a second electronic key, such as the second iButton key 310b, for example, has used a proper programmed second electronic key to access or operate the areas 340b through 340n. Here, access to the area 340a is only provided to the user using the first electronic key having the highest authority identification code therein. If it is determined in operation S610 that the proper programmed second electronic key (i.e., iButton) was used, then the second through n^{th} control areas (i.e., 340b through 340n) are enabled in operations S640 and S650, respectively. As stated above, the second user of the second iButton key (i.e., 310b) is not authorized to access or operate the first area 340a according to a determination of the processor 301 when the second user places the second electronic key into the second key reader 340b (or the single key reader 305 in FIG. 3B).

Next, it is determined in operation S620 whether a third user, attempting to use a third electronic key, such as the third iButton key (i.e., 310c), has used the proper programmed third electronic key to access or operate areas 340c through 340n. If it is determined in operation S120 that the proper programmed third electronic key (i.e., iButton) was used, then the third through n^{th} control areas are enabled in operation S650. Here, the user of the third iButton key (i.e., 310c) is not authorized to access or operate the first or second areas 340a and 340b according to a determination of the processor 301 when the user places the third electronic key into the third key reader 310c (or the single key reader 305 in FIG. 3B).

Similarly, the n^{th} user is not allowed to access or operate the first through (n-1)^{th} areas 340a through 340(n-1) according to the determination of the processor 301 in accordance with the programmed identification code read from the n^{th} iButton key 310n in operation S620. That is, the n^{th} user can access or operate only the n^{th} area 340n, and only within a predetermined time period after using the proper n^{th} iButton key. The predetermined time period is an amount of time that is programmed into the processor 301 to allow access to the area desired to be accessed. An example of a predetermined time period programmed into the processor 301 is approximately one day, for example, to allow performance of daily business activities associated with the respective accessed area. However, it is to be noted that this time period may be changed by re-programming the processor 301, which can be performed by connecting a personal computer (PC) or any other computer system to the processor 301 and re-programming the processor 301 to a different time period.

If the processor 301 determines that the proper identification code or codes within an electronic key (i.e., iButton) have been read by the key reader unit 302, the processor 301 controls locking units (not shown) of the areas 340a through 340n to allow the user to operate or access at least one of the areas 340a through 340n depending on the determination of which electronic keys were read in operations S600, S610, and S620, thereby unlocking the management system (or storage unit management system).

FIG. 7 illustrates a method of operating the security system of FIG. 1, according to another embodiment of the present invention. In this embodiment, all users requesting access to, or operation of the locking device 160 must be present and must use the assigned electronic key simultaneously with the other user(s) in order to gain access to or operation of the locking device 160. More specifically, each user that has an electronic key, and thus authority to gain access to the locking device 160, must be present and use their respective key together with the other user(s) to activate and unlock the locking device 160.

First, the key detecting unit 110 determines whether a first electronic key has been placed up to it and read in operation S700. If the first electronic key has not been read, then the operation starts over. If the first electronic key has been read in operation S700, then the key detecting unit 110 determines whether a second electronic key has been placed up to it and read in operation S710. If the second electronic key has not been read, then the operation S710 continues to check as to whether the second electronic key has been placed up to the key detection unit 110. If the second electronic key has been read by the key detecting unit 110 in operation S710, then the control unit 130 enables the locking component 120 such that the locking device can be accessed.

With the embodiment of FIG. 7, storage areas can be secured from access therein without each of the users with authority therein being present and willing to access the storage area. This embodiment may be applied, for example, to storage areas such as a safety deposit box, or bank safe, wherein each of the owners or users with authority have agreed to be able to access the storage area only when each of the owners or users with authority are present and agree to access the storage area.

As described above, in a security system constructed according to the embodiments of the present invention, the storage units or other valuable items can not be accessed or operated without the proper authorized user being present, thus controlling and increasing the security level of the storage unit or other valuable items.

Moreover, the security system provides heightened security against access or use thereof by an unauthorized user even when the storage units or other valuable items designed with a manufacturer installed locking device, or other simple locking device. Furthermore, the security system can prevent unauthorized users from accessing the storage units or using other valuable items without being given the proper authorization, such as being given a corresponding key to operate the manufacturer installed key locking device.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A security system to increase the security of a manual key operated unit, comprising:
an electronic key reader to read an identification code of an electronic key and to produce a signal according to the read identification code; and
a microprocessor to operate at least one necessary operating component of the manual key operated unit based on whether the signal received by the electronic key reader contains a predetermined identification code.

2. The security system of claim 1, wherein the microprocessor operates the at least one necessary operating component for a predetermined amount of time if the received signal contains the predetermined identification code, otherwise the microprocessor operates the at least one necessary operating component for as long as a manual key operates the manual key operated unit if the manual key is used to operate the manual key operated unit within the predetermined amount of time.

3. The security system of claim 1, further comprising a light indicating unit to indicate whether the read identification code is the predetermined identification code.

4. The security system of claim 3, wherein the light indicating unit comprises:
a first light emitting diode indicating when the detected identification code is correct; and
a second light emitting diode indicating when the detected identification code is not correct.

5. The security system of claim 1, wherein the manual operated key unit is a motor vehicle.

6. The security system of claim 1, wherein the manual operated key unit is a storage unit.

7. The security system of claim 1, wherein the manual operated key unit is a gun cabinet.

8. A security system to secure an external unit having plural separate units secured by a respective locking device, comprising:
a key detecting unit to detect electronic keys; and
a control unit to control enabling or disabling of the locking devices of the separate units depending on the electronic key detected by the key detecting unit.

9. The security system of claim 8, wherein the security system further comprises locking components, each locking component to connect with a respective locking device of the external unit to enable or disable the locking device, the locking components being controlled by the control unit.

10. The security system of claim 8, wherein the key detecting unit detects a programmed identification code within the electronic key.

11. The security system of claim 9, wherein the control unit is a microprocessor that controls the locking components to enable or disable the respective locking devices depending on a signal received from the key detecting unit indicating whether a specific electronic key has been detected.

12. The security system of claim 11, wherein the microprocessor is programmable to change a code corresponding to the electronic key.

13. The security system of claim 11, wherein the locking components enable the respective locking device for a predetermined amount of time, or if a manufacturer provided key is used to operate the locking device within the predetermined amount of time, then for as long as the manufacturer provided key continues to be used to operate that locking device.

14. The security system of claim 11, wherein the external unit is a management unit to manage business activities, and the separate units are different business management areas.

15. The security system of claim 11, wherein the external unit is a building, and the separate units are areas within the building.

16. The security system of claim 11, wherein the external unit is a motor vehicle engine, and the separate units are components required to activate the motor vehicle engine.

17. The security system of claim 11, wherein the external unit is a gun cabinet, and the separate units are different compartment areas of the gun cabinet.

18. A security system to increase the security of a manual key operated motor vehicle, comprising:
an electronic key reader to read an identification code within an electronic key and to generate a signal indicating the read identification code; and
a microprocessor to enable at least one component of the motor vehicle to be operated by the manual key based on the signal received from the electronic key reader.

19. The security system of claim 18, wherein the microprocessor enables the at least one component to be operated for a predetermined time period or for as long as the manual key is used to operate the at least one component of the motor vehicle if the manual key is used to operate the motor vehicle within the predetermined time period.

20. The security unit of claim 19, wherein the at least one component includes a fuel pump to supply fuel to a motor of the motor vehicle.

21. The security unit of claim 19, wherein the at least one component includes a starter unit to start a motor of the motor vehicle.

22. The security unit of claim 19, wherein the at least one component includes at least one accessory compartment of the motor vehicle.

23. The security unit of claim 21, further comprising an indicator to indicate whether a specific identification code has been read.

24. The security unit of claim 23, wherein the indicator includes:
a green light emitting diode (LED) to indicate when the specific identification code has been read; and
a red light emitting diode (LED) to indicate when the specific identification code has not been read,
wherein the green and red LEDs flash on and off when the motor vehicle engine in not being operated, and turn off when the motor vehicle engine is being operated.

25. The security unit of claim 18, wherein the microprocessor is programmable to change the identification code.

26. A security system to secure multiple areas of a management system, comprising:
a key reader unit to read programmed identification codes within an electronic key and generate a signal indicating the read identification code;
plural electronic locking components each to control the security of a respective area of the management system; and
a processor to control each of the electronic locking components depending on the signal received from the key reader unit.

27. The security system of claim 26, wherein the key reader unit comprises plural electronic key readers each to read a specific programmed identification code and to generate a signal indicating the respective identification code read.

28. The security system of claim 27, wherein the processor controls each of the electronic locking components depending on the signals received from each of the plural electronic key readers.

29. The security system of claim 28, wherein each management system area is controlled by a specific programmed identification code within an electronic key.

30. The security system of claim 26, wherein each management system area is controlled by a specific programmed identification code within an electronic key.

31. The security unit of claim 30, wherein the processor is programmable to change the identification code corresponding to the respective area.

32. The security unit of claim 30, wherein the processor is programmable to change an assignment between the electronic key and one of the multiple areas.

33. A method of controlling access to an external unit having at least one separate area secured by a locking device, the method comprising:
setting the number of times an electronic key has been used to operate the locking device of the at least one separate area to zero after it has been determined that an electronic key has not been used to operate the at least one locking device for a predetermined amount of time;
determining whether an electronic key has been used a predetermined number of times to operate the at least one locking device, and if so, disabling the at least one locking device, otherwise determining if a specific electronic key has been used to operate the at least one locking device;
enabling the at least one locking device to be operated for a predetermined amount of time if the specific electronic key has been used to operate the at least one locking device, otherwise adding counting up by one the number of times an incorrect electronic key has been used to operate the at least one locking device, and then repeating the operation of determining whether an electronic key has been used a predetermined number of times to operate the at least one locking device.

34. A method of controlling the use of a motor vehicle, comprising:
disabling a motor vehicle engine component and/or compartments of the motor vehicle;
determining whether an electronic key having a programmed identification code has been used to operate a motor vehicle engine component and/or compartments of the motor vehicle;
enabling the motor vehicle engine component and/or compartments to be operated by a manufacturer provided key for a predetermined amount of time if the electronic key having a programmed identification code has been used to operate a motor vehicle engine component and/or compartments of the motor vehicle, otherwise continuing to disable the motor vehicle engine component and/or compartments of the motor vehicle from being operated with a manufacturer provided key; and
extending the operation of the motor vehicle engine component and/or compartments by the manufacturer provided key for as long as the manufacturer provided key continues to be used to operate a motor vehicle engine component and/or compartments of the motor vehicle if it is determined that the manufacturer provided key has been used within the predetermined amount of time.

35. A method of controlling access to a management system having plural storage areas, comprising:
determining whether a first type of electronic key having authority to access each of the plurality of storage areas has been detected, and if so, then enabling each of the plurality of storage areas of the management system to be accessed for a predetermined amount of time;
determining whether a second type of key having authority to access specific ones of the plurality of storage areas has been detected, and if so, then enabling each of the specific storage areas of the management system to be accessed for a predetermined amount of time; and
determining whether a third type of key having authority to access select ones of the specific storage areas has been detected, and if so, then enabling each of the select ones of the specific storage areas to be accessed for a predetermined amount of time.

36. The method of claim 35, wherein the predetermined amount of time the amount of time required to conduct daily business activities required by the respective storage area.

37. The method of claim 36, wherein the management system is a bar within a restaurant, and storage areas include the area in which the bar is located, a cash register, a cabinet to lock alcohol therein, and/or a cabinet to store valuable items therein.

38. A method of controlling a lockable area, comprising:
determining whether a first electronic key having a predetermined identification code therein has been detected to operate the lockable area, and if not, then continuing to determine whether the first electronic key has been detected, and if so, then determining whether a second electronic key having another predetermined identification code therein has been detected to operate the lockable area, and if not, then continuing to determine whether the second electronic key has been detected; and
enabling the lockable area to be accessed if the first electronic key and the second electronic key have been detected within a predetermined amount of time.

39. A security system to secure an external unit secured by a locking device which is operated by a local key, comprising:
a key detecting unit to detect an electronic key; and
a control unit to control the locking device of the local unit to be operated by the local key according to the detecting of the electronic key.

40. The security system of claim 39, further comprising:
a locking component disposed between the control unit and the locking device to enable and disable the locking device according to the detecting of the electronic key.

41. The security system of claim 39, wherein the locking device is enabled to be operated by the local key when the key detecting unit detects the electronic key, and the locking device is disabled not to be operated by the local key when the key detecting unit does not detect the electronic key.

42. The security system of claim 39, wherein the key detecting unit and the control unit form an integrated body to be attached to the external unit, and the locking device is disabled not to be operated by the local key when at least one of the key detecting unit and the control unit is removed from the external unit.

43. The security system of claim 39, wherein the key detecting unit generates an identification signal, and the control unit compares the identification signal with a reference signal to generate a control signal to enable and disable the operation of the locking device.

44. The security system of claim 43, wherein the control unit counts the number of times when the key detecting unit generates the identification signal which is different from the reference signal, and disable the locking device when the number of times is greater than a predetermined number.

45. The security system of claim 44, wherein the control unit starts to receive the identification signal when the control unit is reset by an external controller.

46. The security system of claim 39, wherein the control unit enables the locking device to be operated by the local key for a predetermined period of time when the identification signal is the same as the reference signal.

47. The security system of claim 46, wherein the control unit continues to enable the locking device to be operated by the local key when the locking device is operated by the local key within the predetermined period of time.

48. The security system of claim 47, wherein the control unit disables the locking device when the locking device is not operated by the local key.

49. The security system of claim 39, wherein the external device is a vehicle having an engine activated by the local key through the locking device, and the control unit enables the engine to be activated by the local key depending on the electronic key.

50. The security system of claim 39, wherein the external device is a container accessible using the local key, and the control unit locking device, and the enables the container to be accessed using the local key depending on the electronic key.

51. The security system of claim 39, wherein the external device is a gun cabinet, and the control unit disables the gun cabinet not to be operated by the local key.

52. The security system of claim 39, wherein the external device comprises a first compartment and a second compartment, the locking device comprises a first locking member and a second locking member installed in the first and second compartments, respectively, and the first and second locking members are operable by the control unit according to the detecting of the electronic key while one of the first and second locking members is operable using the local key.

53. The security system of claim 52, wherein the control unit enables the one of the first and second compartments to be accessed using the local key while the other one of the first and second compartments is operable when the key detecting unit detects the electronic key.

54. The security system of claim 39, wherein the local key is one of another electronic key and a manual key, and the locking device is one of an electronic locking device and a manually locking device corresponding to the local key.

55. The security system of claim 39, wherein the control unit comprises a microprocessor to store a reference identification code corresponding to the electronic key, and the microprocessor is programmable to change the identification code.

56. The security system of claim 55, wherein the control unit is disabled when the key detecting unit receives a identification code different from the stroed reference code more than a predetermined times.

57. The security system of claim 56, wherein the control unit is reset to be enabled when the microprocessor is reprogrammed.

58. A security system to secure an external unit secured by first and second locking devices one of which is operable by a local key, comprising:
a key detecting unit to detect an electronic key; and
a control unit to control the first and second locking devices to be operable depending on the detecting of the electronic key, and to control the first locking device not to be operable by the local key.

59. The security system of claim 58, wherein the control unit controls the second locking device to be operable by the local key without the detecting of the electronic key.

60. The security system of claim 58, wherein the control unit controls the first and second locking devices to be operable without the local key.

61. The security system of claim 58, wherein the external unit comprises a second key detecting unit disposed separate from the key detecting unit to detect the local key.

62. The security system of claim 58, wherein the key detecting unit detects the local key, and the control unit controls one of the first and second locking devices to be operable when the key detecting unit detects the local key.

63. The security system of claim 20, wherein the control unit comprises a microprocessor to store identification codes corresponding to the electronic key and the local key.

64. A security system to secure an external unit secured by a locking device operable by a local key, comprising:
a key detecting unit to detect an electronic key; and
a control unit to control the locking device to be operable depending on the detecting of the electronic key so that the external unit is operable depending on the electronic key and the local key.

65. The security system of claim 64, wherein the control unit controls the locking device not to be operable only by the local key.

66. The security system of claim 64, wherein the external unit is a motor vehicle having an engine to be activated by the local key when the key detecting unit detects an electronic key.

67. The security system of claim 64, wherein the external unit is a motor vehicle having an engine, and the local key is an ignition key.

68. The security system of claim 64, wherein the control unit comprises a microprocessor to control functions of the engine according to the electronic key and the ignition key.

69. The security system of claim 64, wherein the external unit comprises an accessory compartment to be accessible by the local key and the electronics key.

70. The security system of claim 64, wherein the key detecting unit is mounted on an outside of the external unit while the control unit is mounted on an inside of the external unit, and the control unit disables the locking device when one of the key detecting unit and the control unit is detached from the external unit.

71. The security system of claim 64, wherein the control unit receives signals from the key detecting unit and the locking device to determine whether the electronic key and the local key are accessed to the key detecting unit and the locking device, respectively, to enable the locking device.

72. A method of securing an external unit secured by a locking device which is operated by a local key in a security system, the method comprising:
detecting an electronic key; and
controlling the locking device of the local unit to be operated by the by the local key according to the detecting of the electronic key.

73. A method of securing an external unit secured by first and second locking devices one of which is operable by a local key in a security system, the method comprising:
detecting an electronic key; and
controlling the first and second locking devices to be operable depending on the detecting of the electronic key, and controlling the first locking device not to be operable by the local key.

74. A method of securing an external unit secured by a locking device operable by a local key in a security system, the method comprising:
detecting an electronic key; and
controlling the locking device to be operable depending on the detecting of the electronic key so that the external unit is operable depending on the electronic key and the local key.
